(19) United States
(12) Patent Application Publication
(10) Pub. No.: US 2002/0152460 A1
(43) Pub. Date: Oct. 17, 2002

(54) Seamless system and method for identifying, recording and storing user navigational information for interactive television

(76) Inventor: Steven Soloff, Tamarac, FL (US)

Correspondence Address: HUGHES ELECTRONICS CORPORATION, PATENT DOCKET ADMINISTRATION, BLDG 001 M/S A109, P O BOX 956, EL SEGUNDO, CA, 902450956

(21) Appl. No.: 09/851,689

(22) Filed: May 8, 2001

Related U.S. Application Data
(60) Provisional application No. 60/268,481, filed on Feb. 12, 2001.

(51) Int. Cl. H04N 7/16; H04N 7/20; H04H 9/00

(52) U.S. Cl. 725/14; 725/11; 725/9; 725/63

(57) ABSTRACT

A system and method that tracks, compiles and stores satellite television user navigational information, without the user being made aware that any data manipulation is taking place. The invention allows advertisers of products or services on satellite television channels to receive compiled television viewer navigational information such as the time of day, the amount of time a user spends viewing a particular advertisement, or “scene” and the location of the viewer. The invention, adaptable for a traditional satellite-communications network (10), includes a series of computer-readable instructions stored at a satellite user's IRD (35), which can be downloaded to allow for navigational tracking. The identity of the scene being viewed, the time of day of that particular viewing, and the length of time spent viewing the scene is logged, temporarily stored in RAM, and its contents flushed to non-volatile memory at predetermined intervals. Periodically, the navigational log information can then be transmitted to a remote site (55), where it can be processed and converted to statistical records to provide valuable marketing information for the provider.

### BACKGROUND OF THE INVENTION

1. Field of the Invention

The invention generally relates to satellite television networks and more specifically to a method and system of tracking a user's progress as he or she navigates through various content in a satellite-based interactive television network.

2. Description of the Prior Art

Coinciding with the growth of the Internet, the fastest growing technology of our generation, interactive television usage has increased dramatically in recent years and will continue to grow in the new century. The interactive nature of satellite television is providing users with a means of obtaining information, such as requested television programs, movies, news reports and travel information, on demand. On the other hand, the providers of the information, particularly the companies that provide advertisements via satellite television, also benefit. These companies receive the benefits of having millions and millions of satellite television viewers view their advertisements displayed on the viewer's television or computer screen.

Satellite television continues to represent a unique forum in which companies can advertise their products and services to a virtual infinite number of potential customers. Satellites have had a significant impact on the television industry. With an orbital location so far from earth, satellites transmit a usable signal over a broad footprint. The large geographical coverage of satellites makes it possible to serve thousands, if not millions, with a single satellite.

With the increased usage of satellite-based communication systems and specifically interactive television, it is desirous for companies that advertise and provide products and services via satellite television to obtain viewer usage information to determine if and when their advertisements and programs are being viewed. This provides valuable marketing information, enabling companies to alter their advertisements and marketing strategies accordingly. Viewer usage information can include the identity of the information, the time of day the information is being viewed, the duration of viewing time, and the geographical location of the viewer.

Companies that provide weather or ski condition reports on satellite television channels may want to compile and obtain information regarding who is using their services and the most popular time of day that their services are being utilized. Further, these providers would need to know the length of time a user in a particular geographic location spends utilizing the service. Companies can then target their marketing strategies in these areas.

Because companies would be interested in determining where viewers of their advertisements are located, it is desirable to obtain tracking information which includes the location of each user. Since each subscriber that receives satellite-broadcast television signals uses an Integrated Receiver/Decoder (IRD) with a specific ID number, it is desirable to determine where the user is located. This is accomplished by utilizing the specific ID number of that subscriber's IRD.

Accordingly, what is needed in the art is a system and method for collecting user navigational information in a satellite-television network, and storing the information in a time-sequential and completely unobtrusive manner, such that providers of scene information can collect and analyze the navigational information to obtain usage profiles in order to better market their products and services.

It is, therefore, to the effective resolution of the aforementioned problems and shortcomings of the prior art that the present invention is directed.

### SUMMARY OF THE INVENTION

The basic components of a satellite system are one or more transmitting broadcast stations, the uplink of broadcast signals to one or more communication satellites and the downlink of signals to one or more receiving earth stations. The typical communications satellite is a radio relay operating in space for ten or more years without the need for on-site servicing or adjustment. Satellites contain transceivers that receive and transmit signals, including video programming, telephone calls and data. They operate in a vacuum at a location exposed to extreme temperature changes. The receiving earth stations can be a user's receiving antenna coupled to the IRD. The IRD communicates with the user's viewing device.

The present invention is a system and method for identifying and processing satellite-based television usage and navigational data. The method comprises generating scenes, representing a provider's service or advertisement of a product or service. The scenes are included in traditional satellite television broadcasts. The scenes are displayed on a user viewing device such as a television, personal computer or PDA located at a user location.

A computer program stored in a computer readable medium, such as a computer's hard drive, a CD-ROM, or magnetic tape, for example, include instructions for determining when a user transitions from a first scene to a subsequent scene and identifies the scene being viewed by the user, the time of day and duration of the viewing, and the location of the user at the time of transition. All of this information comprises a navigational log record, which is temporarily stored in a temporary memory storage device, such as Read-Only Memory (RAM).

The navigational log record is stored temporarily in RAM, and is then transferred, either at a predetermined time or upon a command, to a non-volatile memory storage area, preferably FLASH memory. The data is stored in a time-sequential manner. Entries are stored until memory limitations are met. At that point, new entries will overwrite the earliest entries.

The non-volatile memory storage means is preferably located at the user location. The user receives navigational tracking software, which he or she can download directly. Periodically, the stored navigational log record can be transmitted to a remote processing location by a modem or other transmitting means such as RF transmission.

In the preferred embodiment, the step of storing the navigational log record includes first determining if the scene being viewed by the user has already been recorded in memory, then determining if the capacity of the non-volatile memory has been reached. If the scene has already been viewed or if the storage capacity of the memory has been reached, no action is taken until either the memory contents have been flushed or until the user enters another transition key. If necessary, the array of stored scene identification information is reallocated to make room for the next navigational log entry.

In the preferred embodiment, the flushing of the contents from temporary storage (RAM) to permanent storage (non-volatile memory such as FLASH) includes the steps of opening an index and database file, determining the next available write location in the database file, and writing each entry in the navigational log record into the database file.

The present invention is a satellite television navigation system that tracks the user as he or she navigates through scenes in an interactive television application. The identification number of each page visited, including the time and date of each visit, and the identification number of the user's IRD is recorded in nonvolatile FLASH memory for a pre-determined time period, until it is requested and sent back to a remote site, via traditional modem connection, where it can be analyzed.

An analyst at the remote site, upon receiving the information, can generate a large statistical database of user viewing habits relating to interactive applications. Companies and marketing agencies can use this information to get a feel for user interest in certain advertisements and to help create and revise marketing strategies.

It is to be understood that both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

In accordance with these and other objects which will become apparent hereinafter, the instant invention will now be described with particular reference to the accompanying drawings.

### BRIEF DESCRIPTION OF THE DRAWINGS

FIG. 1 illustrates a typical satellite-based communication system utilizing the present invention.

FIG. 2 illustrates a flowchart showing the step-by-step process taking by a user to invoke the subroutine that logs the page currently being viewed.

FIG. 3 illustrates a flowchart showing the step-by-step process taking by a user to invoke the subroutine that flushes the navigational log content from temporary memory to permanent memory.

FIG. 4 illustrates a flowchart showing the step-by-step process of recording navigational log information utilized by the present invention.

FIG. 5 illustrates a flowchart showing the step-by-step process of storing navigational log information utilized by the present invention.

### DESCRIPTION OF THE PREFERRED EMBODIMENTS

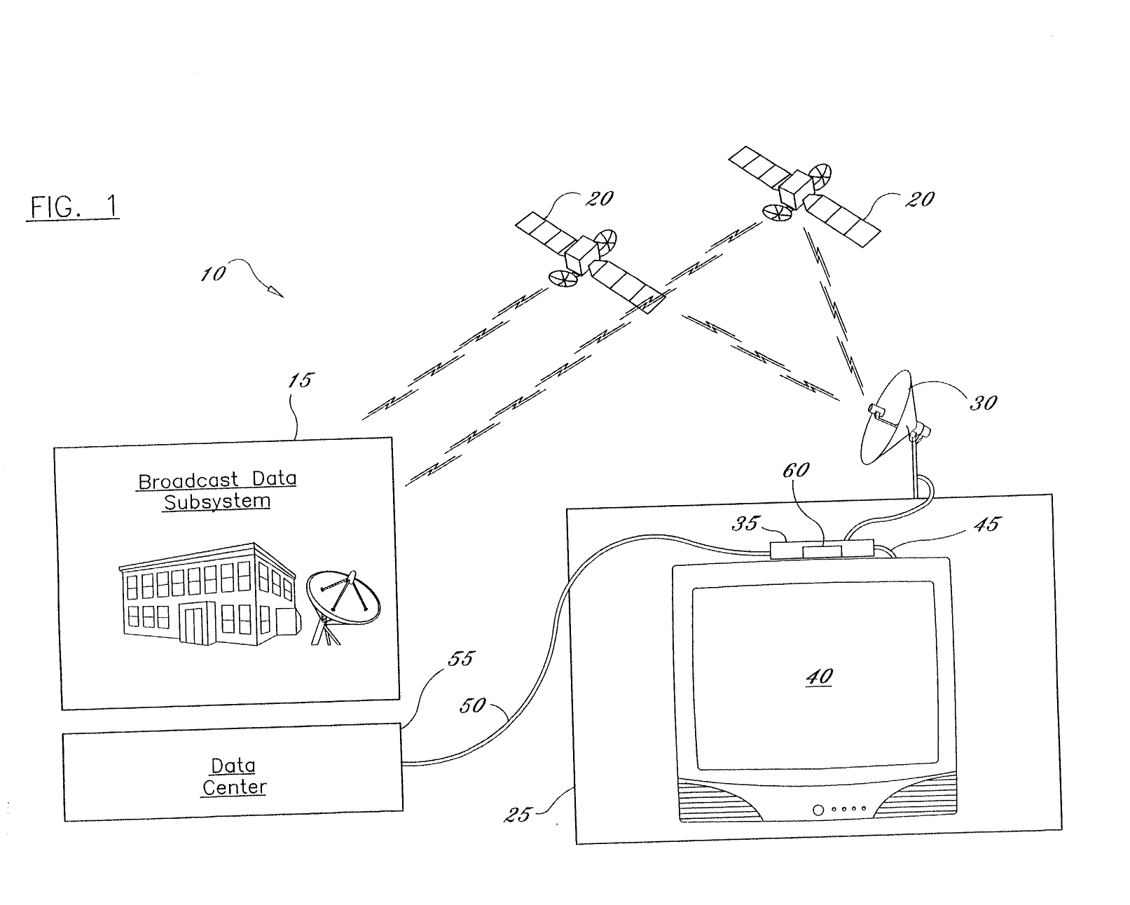

Referring to FIG. 1, the system architecture of a typical satellite-based communication system is shown.

In a conventional satellite-television network 10, television content is broadcast from a broadcast center 15 at a remote location. The content is uplinked to one or more communication satellites 20. A user, at a location within the satellite's footprint 25, receives the broadcast via his or her satellite dish antenna 30. The signal is then passed on to the user's IRD 35. IRD 35 is connected to the user's television or other data viewing device 40 via a standard connection such as a serial data cable 45. The user then tunes his or her viewing device to receive the broadcast signal at a selected channel.

The present invention provides a method of tracking a user's progress through television channels and advertisements displayed on the channels. A computer program comprising a series of computer instructions is stored in a digital storage medium, located in the IRD itself. The computer instructions record the identification number of each scene on a channel visited by the user, including the time and date of each visit. This is accomplished by one or more objects, or “gadgets”, which encapsulates the functionality necessary to log navigation information to a system navigation file.

The navigational information is collected, and initially stored in RAM, where it is periodically flushed to a non-volatile medium such as FLASH memory. It can then be transmitted, via traditional data communication means, preferably a modem 50, to the original broadcast center 15 or to a remote data center 55, where the data is processed, and reports based upon the navigational data can be generated. In an alternate embodiment of the method of the present invention, the navigational information can be transmitted either to broadcast center 15 or remote data center 55 via traditional, wireless communication means.

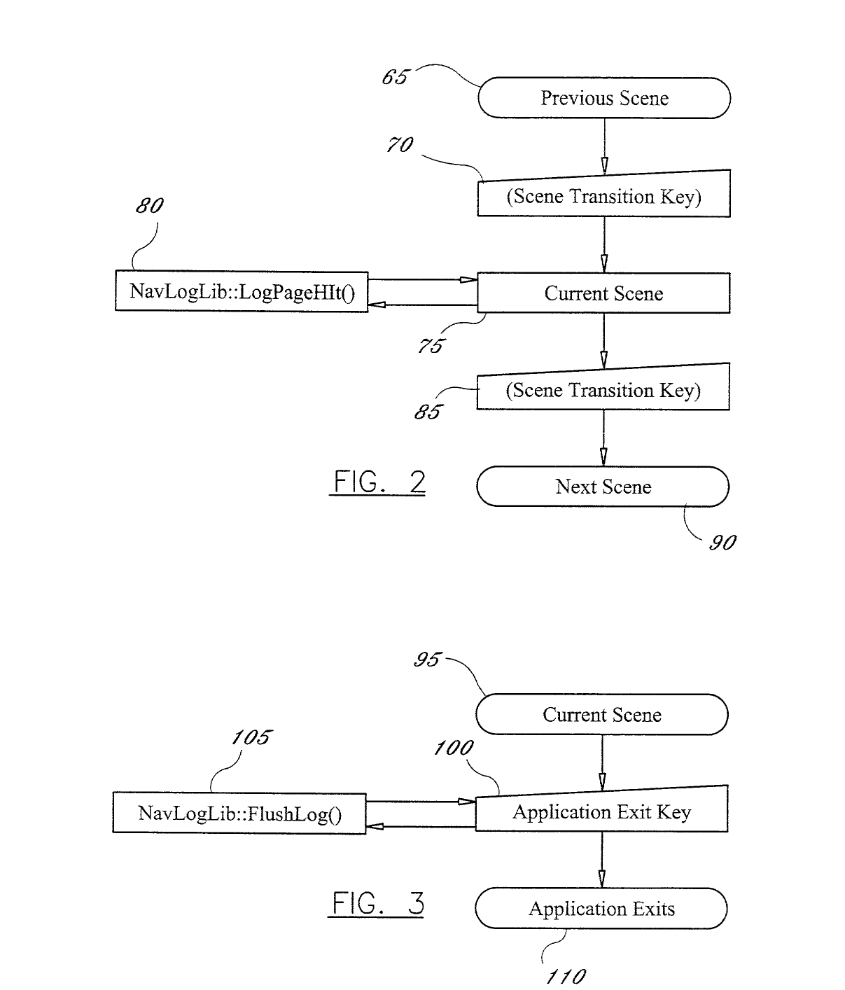

FIGS. 2 and 3 illustrate the functional steps taken by a satellite television user utilizing the present invention. After viewing a particular channel and advertising information (“scene”) 65 displayed thereon, the user enters a transition key 70 that takes him or her to a new scene 75. Transition key 70 can be the manual switching of television channels or by use of a standard remote control device. Once a transition key 70 is entered, a new channel is contacted and a new scene (the “Current Scene”) 75 is displayed.

The scenes viewed by the user can contain any type of informative news such as weather reports, skiing or surfing conditions, local news, or general advertisements. It is the companies that display these “scenes” that would be interested in the number of users viewing the scenes, the time of day it is being viewed, how long the user views the scene and the location of the user (tracked by the IRD identification number) viewing the scene.

Once the scene transition has occurred, it is recognized by the computer program which then calls the string, “NavLogLib::LogPageHit” (“PAGEHIT”) 80. PAGEHIT 80 recognizes a page hit, and records the page hit and associated scene information, temporarily in RAM. The entire transition is seamless, and goes completely unnoticed by the user. After the scene being viewed by the user is recorded, no action is taken until the user enters another scene transition key 85, taking him or her to the next scene 90, where the steps are repeated.

Referring to FIG. 3, from the current scene 95, the application ends either at the request of the user or at a predetermined moment, as indicated by step 100. At this point, the subroutine NavLog::FlushLog( ) (“FLUSHLOG”) 105 is called and the navigational content is flushed from RAM, where it was being temporarily stored, to a non-volatile medium, preferably FLASH memory. The application terminates at this point 110.

The following resource structure initializes data for the gadget:

| typedef struct _GLA_NavLogResource | | |
|---|---|---|
| { | | |
| | o_producer_id | dwProducerID; |
| } | o_application_id | dwApplicationID; |

} GLA_NavLogResource;

The “dwProducerID” command specifies the producer ID of the application that wants to log the navigation information. The “dwApplicationID” command specifies the application ID of the application that is to be used to log the navigation information.

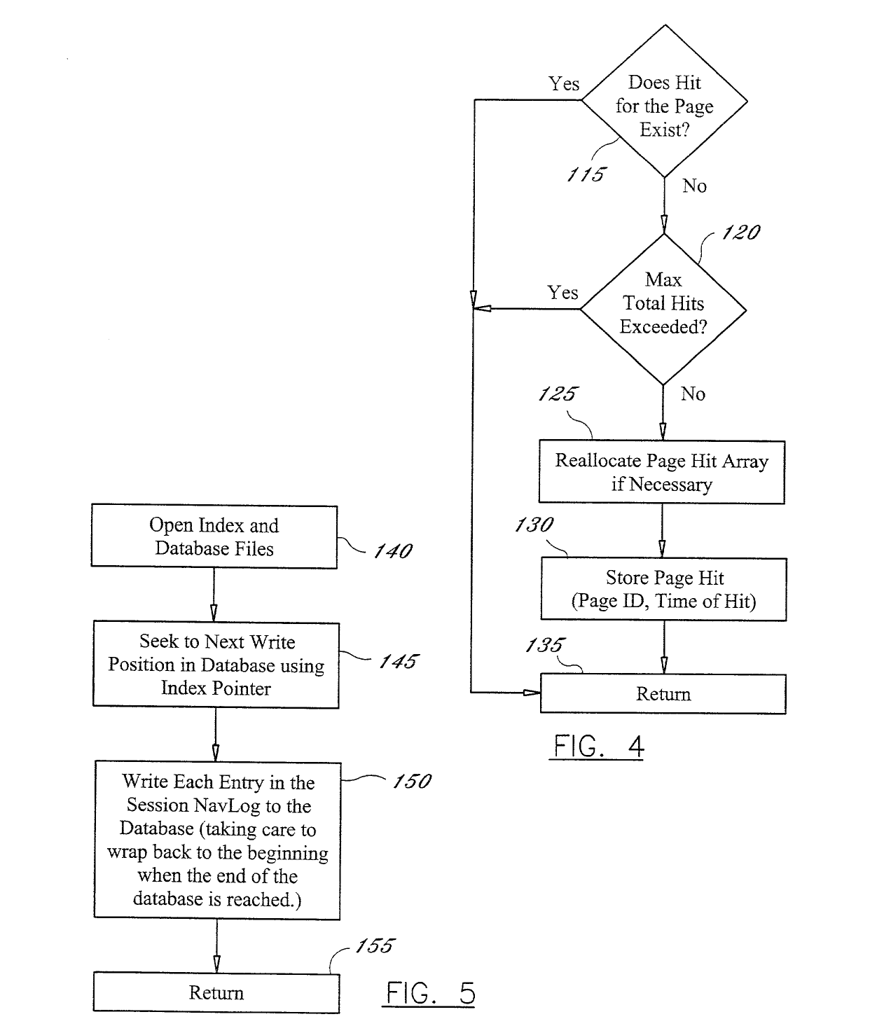

Referring to FIG. 4, once the PAGEHIT 80 subroutine is invoked, via the entering of a scene transition key, several steps are taken to assure that a proper transfer of navigational information will take place. The non-volatile memory, which is to receive the navigation information, is checked to determine if a “hit” has been already entered and stored for this particular application page, by this particular user, via step 115. If so, no action is taken and the process returns to the user functional flow of FIG. 2, step 135. When a new scene, or page, is contacted via a transition key entry 70, the process continues, beginning again with step 115.

If the scene is being contacted for the first time by this particular user, the corresponding information needs to be recorded. The gadget checks the storage capacity of the non-volatile memory to see if its limitation has been reached, via step 120. In the preferred embodiment, the memory limitation is 30 kB, although it is in the spirit of the invention to allocate additional memory, if additional navigational data capacity is needed. If the memory capacity has been reached, once again, no action is taken. The memory will remain full until its contents are transmitted, either at a predetermined time, or upon command, to a local or remote site where the data can be processed into statistical reports via conventional means.

If there is space available in the non-volatile memory, the array of information stored there may have to be reallocated, via step 125, to provide space for the newly-entered information, keeping the data in sequential order. After this step has taken place, the scene identification number, the time of day of the “hit” and the time the user spends on that page, is recorded in RAM, via step 130. Because each user IRD has a corresponding identification number, this ID number in conjunction with the IRD manufacturer's sales records, if available, can be used to determine the geographic location of the IRD, and therefore, its user. Once again, the memory storage limitations will have to be increased accordingly, if necessary.

Referring once again to FIG. 3 when the application is exited (i.e. the television is no longer in use, or if the user remains at one scene for a predetermined amount of time, or any other automated or user or provider-initiated action), the remaining contents of the navigation log encapsulated by PAGEHIT 80 and stored in RAM is flushed to non-volatile memory, via the routine FLUSHLOG 105. FIG. 5 illustrates the steps taken during this routine.

In FIG. 5, the first step in flushing the navigational data from RAM to non-volatile memory is to create database files in non-volatile memory via step 140 and to determine the next available position in the database capable of receiving data using an index pointer, step 145. The navigational log entries stored via PAGEHIT 80 are then written to the database. The entries are written in time-sequential order via step 150. If the memory capacity is reached, the earliest entries are replaced by the most recent entries.

The non-volatile memory stores the navigational information in a time-sequential manner. Once capacity has been reached, the next entry is stored and the very first entry is replaced by it. This wrap-around feature allows the invention to operate within a given memory storage capacity. Should it be necessary to compile additional navigational parameters, the memory storage capacity can be increased accordingly.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A system for identifying and processing satellite based television usage and navigational data comprising:
means for generating promotional scenes, said scenes to be included in traditional satellite broadcasts;
means for displaying said scenes on a viewing device located at a user location;
means for determining when a user transitions from a first scene to a subsequent scene;
means for identifying and recording the scene being viewed by the user and the time of day and duration of said viewing at the time of said user transition, thereby creating a navigational log record; and
means for storing said navigational log record in a memory storage device.

2. The system of claim 1 further comprising means for determining the geographical location of the user viewing said scene.

3. The system of claim 1 wherein said means for storing said navigational log record includes means for temporarily storing said log record in a temporary memory storage device and means for transmitting the contents of said temporary memory storage device to a permanent memory storage device.

4. The system of claim 3 wherein said permanent memory storage device is comprised of FLASH memory.

5. The system of claim 4 further comprising means for periodically transmitting said navigational log record stored in said permanent memory storage device to a remote processing location.

6. The system of claim 5 wherein said transmitting means is a modem.

7. The system of claim 5 wherein said transmitting means is traditional wireless data transfer means.

8. The system of claim 3 wherein said means for temporarily storing said navigational log record includes means for determining if a scene's navigational log record has already been recorded, means for determining if the capacity of said permanent memory device has been reached, and means for reallocating, if necessary, an array of stored scene information to create space for an additional navigational log record.

9. The system of claim 3 wherein said means for transmitting the contents of said temporary memory storage device occurs at a predetermined time.

10. The system of claim 3 wherein said means for transmitting the contents of said temporary memory storage device includes means for opening an index and database file in said permanent memory storage device, means for determining a next available write location in said database file, and means for writing each entry in said navigational log record into said database file.

11. The system of claim 9 further comprising means for recording the latest recorded navigational log record into said database file even when the storage capacity of said permanent memory storage device has been attained.

12. A method for identifying and processing satellite based television usage and navigational data, said method comprising the steps of:
generating promotional scenes, said scenes to be included in traditional satellite broadcasts;
displaying said scenes on a viewing device located at a user location;
determining when a user transitions from a first scene to a subsequent scene;
identifying the scene being viewed by the user and the time of day and duration of said viewing at the time of said user transition, thereby creating a navigational log record; and
storing said navigational log record in a memory storage device.

13. The method of claim 12 further comprising the step of determining the geographical location of the user viewing said scene.

14. The method of claim 12 wherein said step of storing said navigational log record includes temporarily storing said log record in a temporary memory storage device and transmitting the contents of said temporary memory storage device to a permanent memory storage device.

15. The method of claim 14 wherein said permanent memory storage device is comprised of FLASH memory.

16. The method of claim 14 further comprising the step of periodically transmitting said navigational log record stored in said permanent memory storage device to a remote processing location.

17. The method of claim 16 wherein the step of transmitting said navigational log record to said remote processing center is via a modem.

18. The method of claim 16 wherein the step of transmitting said navigational log record to said remote processing center is via traditional wireless data transfer means.

19. The method of claim 14 wherein the step of temporarily storing said navigational log record includes determining if a scene's navigational log record has already been recorded, determining if the capacity of said permanent memory device has been reached, and reallocating an array of stored scene information to create space for an additional navigational log record.

20. The method of claim 14 wherein the step of transmitting the contents of said temporary memory storage device occurs at a predetermined time.

21. The method of claim 14 wherein the step of transmitting the contents of said temporary storage device includes opening an index and database file in said permanent memory storage device, determining a next available write location in said database file, and writing each entry in said navigational log record into said database file.

22. The method of claim 21 further comprising the step of recording the latest recorded navigational log record into said database file even when the storage capacity of said permanent memory storage device has been attained.

23. A satellite-based communications network for identifying and processing satellite based television usage and navigational data comprising:
a broadcast center for broadcasting information;
one or more communication satellites for receiving said broadcast information;
user receiving means situated within said satellite's coverage area to receive said broadcast information;
a viewing device connected to said user receiving means;
video image selection means for providing a user with a means of transitioning from one scene to a subsequent scene, wherein said video image comprises said broadcast information; and
means for compiling user navigational data, wherein said navigational data includes the identification of the scene being viewed, the time the user is viewing said scene, the length of time of said viewing, and the location of the user viewing said scene.

24. The satellite-based communications network of claim 23 further comprising means for periodically transmitting said stored navigational log record to a remote processing location.

25. A computer program stored in a computer readable medium, embodying instructions to perform a method of tracking satellite-based television usage characteristics, said method comprising the steps of:
determining when a user transitions from a first scene being displayed on a user's viewing device to a subsequent scene displayed upon said viewing device, wherein said scenes comprise information included in traditional satellite television broadcasts;
identifying the scene being viewed by the user and the time of day and duration of said viewing at the time of said user transition, thereby creating a navigational log record; and
storing said navigational log record in a memory storage device.

26. The method of claim 25 further comprising the step of determining the geographical location of the user viewing said scene.

27. The method of claim 25 wherein said step of storing said navigational log record includes temporarily storing said log record in a temporary memory storage device and transmitting the contents of said temporary memory storage device to a permanent memory storage device.

28. The method of claim 27 wherein said permanent memory storage device is comprised of FLASH memory.

29. The method of claim 27 further comprising the step of periodically transmitting said navigational log record stored in said permanent memory storage device to a remote processing location.

30. The method of claim 29 wherein the step of transmitting said navigational log record to said remote processing center is via a modem.

31. The method of claim 29 wherein the step of transmitting said navigational log record to said remote processing center is via traditional wireless data transfer means.

32. The method of claim 27 wherein the step of temporarily storing said navigational log record includes determining if a scene's navigational log record has already been recorded, determining if the capacity of said permanent memory device has been reached, and reallocating an array of stored scene information to create space for an additional navigational log record.

33. The method of claim 27 wherein the step of transmitting the contents of said temporary memory storage device occurs at a predetermined time.

34. The method of claim 27 wherein the step of transmitting the contents of said temporary storage device includes opening an index and database file in said permanent memory storage device, determining a next available write location in said database file, and writing each entry in said navigational log record into said database file.

35. The method of claim 34 further comprising the step of recording the latest recorded navigational log record into said database file even when the storage capacity of said permanent memory storage device has been attained.
